(19) United States
(12) Patent Application Publication
(10) Pub. No.: US 2012/0315535 A1
(43) Pub. Date: Dec. 13, 2012

(54) SECONDARY BATTERY

(75) Inventor: Kazuaki Matsumoto, Tokyo (JP)

(73) Assignee: NEC CORPORATION, Tokyo (JP)

(21) Appl. No.: 13/579,859

(22) PCT Filed: Jan. 12, 2011
(86) PCT No.: PCT/JP2011/050795

§ 371 Date: Aug. 17, 2012

(30) Foreign Application Priority Data
Feb. 19, 2010 (JP) 2010-034973

(51) Int. Cl. H01M 10/056

(52) U.S. Cl. 429/188

(57) ABSTRACT

This invention provides an electricity storage device having improved characteristics by optimizing battery materials, particularly an electrolyte solution. The electrolyte solution (4) contains metal ions other than lithium ions which are injected into an organic solvent comprising a lithium salt dissolved therein by immersing in the solvent two different metals mutually connected by means of an electrically conductive material.

### TECHNICAL FIELD

This invention relates to an electrolyte solution capable of improving battery characteristics and a secondary battery using such an electrolyte solution.

### BACKGROUND ART

In recent years, studies have been conducted in order to further increase the capacity and energy density of electricity storage devices comprising secondary batteries for use in mobile devices such as cell phones, and secondary batteries required for large-scale storage of electricity and automobiles.

Among these electricity storage devices, secondary batteries which can be repeatedly charged and discharged, and especially lithium secondary batteries having high energy density have become mainstream.

A lithium secondary battery comprises a positive electrode, a negative electrode, and an electrolyte (or electrolyte solution).

In general, a lithium-containing transition metal oxide is used as a positive electrode active material of a lithium secondary battery, while a lithium metal, a lithium alloy, or a material occluding or releasing lithium ions is used as a negative electrode active material.

As an electrolyte of a lithium secondary battery, an organic solvent comprising a lithium salt such as lithium tetrafluoroborate (LiBF₄) or lithium hexafluorophosphate (LiPF₆) dissolved therein is used. Ethylene carbonate, propylene carbonate or the like is used as the organic solvent.

Materials for a negative electrode of a lithium secondary battery further comprises a material composed of a carbon material such as graphite, hard carbon, or coke, or a material that can be alloyed with lithium, such as tin, silicon, aluminum, or silicon oxide.

An example of the lithium secondary batteries is described in Japanese Laid-Open Patent Publication No. 2000-100421 (Patent Document 1) which discloses a non-aqueous electrolyte secondary battery in which graphite is employed as a negative electrode active material. In the non-aqueous electrolyte secondary battery of Patent Document 1, ester phosphate is used as a major component of a solvent of an electrolyte solution in order to provide the electrolyte solution with flame retardancy and to enhance safety. Further, in the non-aqueous electrolyte secondary battery of Patent Document 1, the electrolyte solution further contains at least one of compounds comprising unsaturated aliphatic ether radicals or unsaturated aliphatic ester radicals in order to enable charge and discharge of the graphite in the electrolyte solution comprising ester phosphate as a major component of the solvent, and in order to provide a non-aqueous electrolyte secondary battery having a high initial charge-discharge efficiency and having good load characteristics.

On the other hand, there exist demands for secondary batteries having still higher capacity, and studies are being made to use a material such as a silicon, silicon oxide, or tin as a negative electrode material in place of the prevalent electrode materials comprising a carbon material as disclosed in Patent Document 1.

### DISCLOSURE OF THE INVENTION

As described above, there exist demands for secondary batteries having still higher capacity and higher energy density. According to prior art, an electrode material itself must be changed in order to increase the capacity. Not only improvement is desired for electrode materials, but also optimization is desired for electrolyte solution materials having significant effects on battery characteristics.

This invention has been made in view of the drawbacks in the prior art, and it is an object of the invention to provide a secondary battery having improved characteristics by changing or modifying the battery materials, especially the electrolyte solution, more specifically to provide a secondary battery having higher capacity and higher energy density than conventional second batteries.

### MEANS FOR SOLVING THE PROBLEMS

In order to achieve the object described above, an aspect of this invention provides an electrolyte solution characterized by containing metal ions other than lithium ions, which are injected into an organic solvent comprising a lithium salt dissolved therein by immersing in the solvent two different metals mutually connected by means of an electrically conductive material.

Another aspect of the invention provides a secondary battery which comprises a positive electrode containing an oxide capable of occluding and releasing lithium ions, a negative electrode containing a material capable of occluding and releasing lithium ions, and the electrolyte solution described above.

Another aspect of the invention provides a method of manufacturing an electrolyte solution characterized by injecting, into an organic solvent comprising a lithium salt dissolved therein, metal ions other than lithium ions by immersing in the solvent two different metals mutually connected by means of an electrically conductive material.

### ADVANTAGEOUS EFFECT OF THE INVENTION

According to this invention, a secondary battery having improved characteristics can be provided.

### BRIEF DESCRIPTION OF THE DRAWINGS

FIG. 1 is a schematic diagram showing an example of a basic configuration of a secondary battery according to this invention; and

FIG. 2 is an exploded perspective view illustrating an example of assembly of a coin type secondary battery comprising the basic configuration shown in FIG. 1.

### LIST OF REFERENCE NUMERALS

1 Container
2 Positive electrode
3 Negative electrode
4 Electrolyte solution
10 Secondary battery
11 Stainless-steel outer packaging
12 Positive electrode
13 Negative electrode
15 Insulation gasket
16 Separator
17 Positive electrode collector
20 Coin type secondary battery

### BEST MODE FOR CARRYING OUT THE INVENTION

Firstly, an outline of this invention will be described.

The inventor of this invention has reached this invention as a result of earnest studies to develop a secondary battery having high capacity and high energy density, discovering that a secondary battery is enabled to operate as a high capacity electricity storage device by using, in the secondary battery, an electrolyte solution which is caused to contain metal ions by immersing in the electrolyte solution two different types of metals connected with an electrically conductive material.

The electrolyte solution according to this invention thus contains metal ions other than lithium ions, which are injected into the electrolyte solution by immersing two different types of metals connected with an electrically conductive material (that is, electrically short-circuited) within an organic solvent comprising a lithium salt dissolved therein. These metal ions preferably comprise at least one of magnesium and aluminum ions.

The electrolyte solution according to the invention may contain 20% or more by volume of a phosphorus compound, and may have 1.0 M (mol/L) or more of a lithium salt dissolved therein.

A secondary battery according to this invention using this electrolyte solution comprises a positive electrode containing an oxide capable of occluding and releasing lithium ions, a negative electrode containing a material capable of occluding and releasing lithium ions, and the aforementioned electrolyte solution.

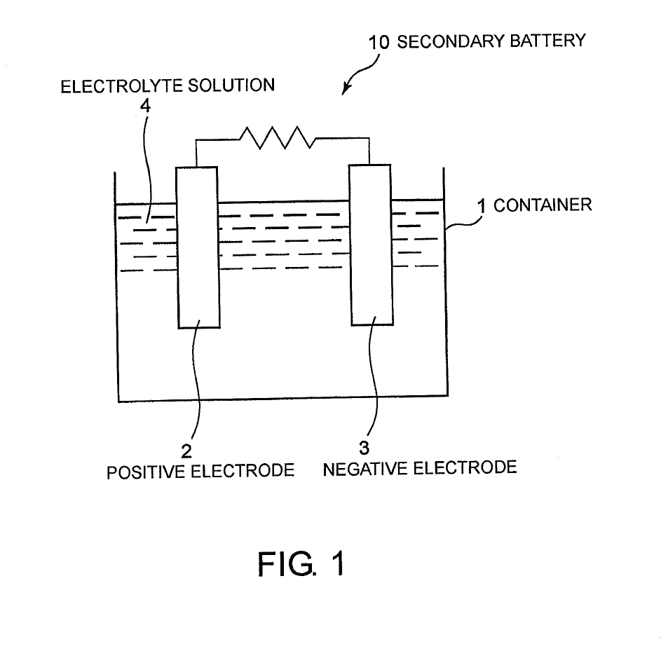

More specifically, as shown in FIG. 1, an exemplary basic configuration of a lithium ion secondary battery 10 according to this invention comprises, at least, a positive electrode 2, a negative electrode 3, and an electrolyte solution 4 stored in a sealed container 1. The positive electrode 2 of the lithium ion secondary battery 10 is formed of an oxide comprising a material occluding and releasing lithium. The negative electrode 3 is formed of a material occluding and releasing lithium, or a material precipitating and dissolving lithium. The electrolyte solution 4 stored in the sealed container 1 contains metal ions.

Next, description will be made on materials used for the lithium ion secondary battery, and methods of producing components thereof. It should be understood that this invention is not limited to these.

Firstly, description will be made of materials used for the lithium ion secondary battery according to the invention, specifically, (A) organic solvent and phosphorus compound as incombustible material thereof (B) film-forming additive; (C) electrolyte solution; (D) positive electrode; (E) negative electrode; (F) separator; and (G) battery shape.

(A) Organic Solvent:

Preferably, an organic solvent as described below is added to the electrolyte solution according to this invention. The organic solvent can be selected from ethylene carbonate (EC), propylene carbonate (PC), butylene carbonate, dimethyl carbonate (DMC), ethylmethyl carbonate (EMC), fluoroethylene carbonate (FEC), chloroethylene carbonate, diethyl carbonate (DEC), dimethoxy-ethane (DME), dimethoxy-methane (DMM), diethoxy-ethane (DEE), diethyl ether, phenylmethyl ether, tetrahydrofuran (THF), tetrahydropyran (THP), 1,4-dioxane (DIOX), 1,3-dioxolane (DOL), acetonitrile, propione nitrile, γ-butyrolactone, and γ-valerolactone. Among these, ethylene carbonate, diethyl carbonate, propylene carbonate, dimethyl carbonate, ethylmethyl carbonate, γ-butyrolactone, and γ-valerolactone are particularly desirable in view of stability, but not limited thereto. The organic solvent preferably has a concentration of 5% by volume or more, and more preferably 10% by volume or more, in order to provide a sufficient effect of improving the capacity.

The organic solvent may be used alone or in combination of two or more.

The electrolyte solution may be mixed with a phosphorus compound to give it flame retardancy. The phosphorus compound may be a compound represented by Chemical Formula 1 or Chemical Formula 2 below.

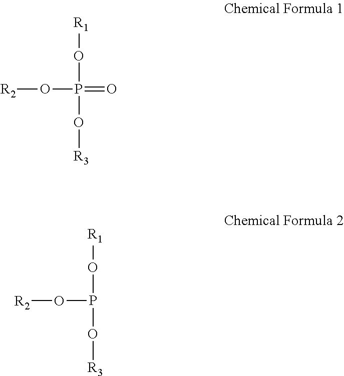

In the Chemical Formulae 1 and 2, R1, R2, and R3 each represent an alkyl group with a carbon number of 10 or less, or an alkyl halide group, an alkenyl group, a cyano group, a phenyl group, an amino group, a nitro group, an alkoxy group, a cycloalkyl group, or a silyl group, and a cyclic structure in which any or all of R1, R2, and R3 are bonded is also comprised.

Specific examples of the compounds represented by the Chemical Formulae 1 and 2 comprise trimethyl phosphate, triethyl phosphate, tripropyl phosphate, tributyl phosphate, tripentyl phosphate, trioctyl phosphate, triphenyl phosphate, dimethyl ethyl phosphate, dimethyl methyl phosphate (DMMP), dimethyl methyl phosphate, and diethyl methyl phosphate and so on.

Examples of the compounds further comprise methyl ethylene phosphate, ethyl ethylene phosphate (EEP), and ethyl butylene phosphate comprising a cyclic structure, and tris(trifluoromethyl)phosphate, tris(pentafluoroethyl)phosphate, tris(2,2,2-trifluoroethyl)phosphate, tris(2,2,3,3-tetrafluoropropyl)phosphate, tris(3,3,3-trifluoropropyl)phosphate, and tris(2,2,3,3,3-pentafluoropropyl)phosphate substituted with an alkyl halide group. Among the compounds mentioned above, more desirable compounds are trimethyl phosphite, triethyl phosphite, tributyl phosphate, and triphenyl phosphite. Particularly desirable compounds are trimethyl phosphate, triethyl phosphate, trioctyl phosphate, and triphenyl phosphate for their high stability.

The phosphorus compound may be a phosphazene derivative comprising a P═N bond. The phosphazene is only required to comprise a P═N bond, and may be one comprising a cyclic structure or may be a polymer.

These phosphorus compounds may be used alone or in combination of two or more. In order to provide the electrolyte solution with flame retardancy by adding a phosphorus compound, 15% by volume or more of the phosphorus compound must be added, and more preferably 20% by volume or more of the phosphorus compound should be added.

(B) Film-Forming Additive:

A film-forming additive as used in this invention is an additive which electrochemically forms a film on the surface of the negative electrode. Specific examples of such an additive comprise vinylene carbonate (VC), vinyl ethylene carbonate (VEC), ethylene sulfite (ES), propane sultone (PS), butane sultone (BS), dioxathiolane-2,2-dioxide (DD), sulfolene, 3-methyl sulfolene, sulfolane (SL), succinic anhydride (SUCAH), propionic anhydride, acetic anhydride, maleic anhydride, diallyl carbonate (DAC), diphenyl sulfide (DPS), and so on. However, the film-forming additive used in the invention is not particularly limited to these. Since an increased additive amount will adversely affect the battery characteristics, the content of the film-forming additive should preferably limited to less than 20% by mass. More preferably, the content should be less than 10% by mass.

(C) Electrolyte Solution:

The function of the electrolyte solution is to transport a charge carrier between the negative and positive electrodes, and an organic solvent comprising a lithium salt dissolved therein, for example, can be used as the electrolyte solution. The lithium salt may be, for example, LiPF₆, LiBF₄, LiAsF₆, LiClO₄, Li₂B₁₀Cl₁₀, Li₂B₁₂Cl₁₂, LiB(C₂O₄)₂, LiCF₃SO₃, LiCl, LiBr, or LiI. Particularly, the lithium salt may be selected from LiBF₃(CF₃), LiBF₃(C₂F₅), LiBF₃(C₃F₇), LiBF₂(CF₃)₂, and LiBF₂(CF₃)(C₂F₅) obtained by substituting at least one fluorine atom of LiBF₄ with a fluorinated alkyl group, and LiPF₅(CF₃), LiPF₅(C₂F₅), LiPF₅(C₃F₇), LiPF₄(CF₃)₂, LiPF₄(CF₃)(C₂F₅), and LiPF₃(CF₃)₃ obtained by substituting at least one fluorine atom of LiPF6 with a fluorinated alkyl group.

Further, the lithium salt may be a salt compound represented by Chemical Formula 3 below.

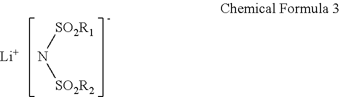

In the Chemical Formula 3 above, R1 and R2 are selected from groups comprising halogen and alkyl fluoride. R1 and R2 may be different from each other, or may be cyclic. Specific examples comprise LiN(FSO₂)₂, LiN(CF₃SO₂)₂, LiN(C₂F₅SO₂)₂, LiN(CF₃SO₂)(C₄F₉SO₂), and five-membered ring compounds CTFSI-Li.

The lithium salt may also be a salt comprising a compound represented by Chemical Formula 4 below.

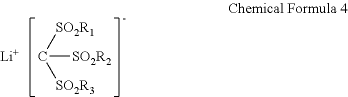

In the Chemical Formula 4 above, R1, R2, and R3 are selected from groups comprising halogen or alkyl fluoride.

R1, R2, and R3 may be different from one another. Specific examples thereof comprise LiC(CF₃SO₂)₃ and LiC(C₂F₅SO₂)₃. These lithium salts may be used alone or in combination of two or more. Among these salts, particularly desirable are LiN(CF₃SO₂)₂ and LiN(C₂F₅SO₂) having high thermal stability, and LiN(FSO₂)₂, LiPF₆ having high ion conductivity.

The concentration of the lithium salt dissolved in the organic solvent is preferably 0.01 M (mol/L) or more, and not more than a saturation concentration, and more preferably 0.5 M (mol/L) or more and not more than 1.5 M (mol/L).

When the electrolyte solution contains a phosphorus compound, the concentration of the lithium salt is preferably 1.0 M (mol/L) or more, more preferably 1.2 M (mol/L) or more, and most preferably 1.5 M (mol/L) or more.

(D) Positive Electrode:

A material for the positive electrode according to this invention may be a lithium-containing transition metal oxide such as LiₓMn₂O₄ (0<x<2), LiCoO₂, LiNiO₂, LiFePO₄ or LiₓV₂O₅ (0<x<2), LiₓNiO₃ (0<x<2), or any such compound whose transition metal is partially substituted with another metal. In this invention, the positive electrode can be formed on a positive electrode collector, and the positive electrode collector may be one formed on a foil or metallic plate comprising nickel, aluminum, copper, gold, silver, an aluminum alloy, stainless-steel, carbon or the like.

(E) Negative Electrode:

A negative electrode material capable of occluding and releasing lithium according to this invention may be silicon, tin, aluminum, silver, indium, antimony, bismuth, aluminum, lithium, calcium or the like, but is not limited to these. Any material can be used as long as it is capable of occluding and releasing lithium. An alloy or oxide of these materials also can be used. When an alloy is used, the alloy may contain two or more types of metallic elements, or one type of metallic element and one or more types of non-metallic elements. When a tin or silicon compound is used, it may be a compound containing, for example, oxygen or carbon. The carbon negative electrode may be selected from carbon materials comprising pyrolytic carbons, cokes (pitch coke, needle coke, petroleum coke, or the like), graphites, vitrified carbons, a sintered body of a polymeric organic compound (obtained by sintering and carbonizing a phenol or furan resin at an adequate temperature), carbon fibers, activated carbon, and graphite. Additionally, a binder may be used to enhance the bonding between the components of the negative electrode. This binder may be selected from polytetrafluoroethylene, polyvinylidene fluoride, vinylidene fluoride-hexafluoropropylene copolymer, vinylidene fluoride-tetrafluoroethylene copolymer, styrene-butadiene rubber, polypropylene, polyethylene, polyimide, partially carboxylated cellulose, various polyurethane, and polyacrylonitrile. The negative electrode according to this invention can be formed on a negative electrode collector, and the negative electrode collector may be one formed on a foil or metal plate comprising nickel, aluminum, copper, gold, silver, an aluminum alloy, stainless-steel, carbon or the like.

(F) Separator:

In the lithium ion secondary battery according to this invention, a separator can be used in order to prevent contact between the positive electrode and the negative electrode, and the separator may be made of a porous film, cellulose film, or non-woven fabric of polyethylene, polypropylene or the like. These materials may be used alone or in combination of two or more.

(G) Battery Shape:

In this invention, the shape of the secondary battery is not limited particularly, and any conventional shape can be employed. The battery shape may be cylindrical, angular, coin-shaped, sheet-shaped, or the like. This type of battery is fabricated by sealing an electrode layered body or wound body formed of the aforementioned positive electrode, negative electrode, electrolyte and separator, with a metal case, a resin case, or a laminated film comprising a synthetic resin film and a metal foil such as an aluminum foil. However, this invention is not limited to these shapes.

Next, methods of producing (a) electrolyte solution, (b) positive electrode, (c) negative electrode, and (d) coin type secondary battery according to this invention will be described sequentially.

(a) Production Method of Electrolyte Solution:

An electrolyte solution is produced within a dry room by dissolving a certain concentration of a lithium salt in an organic solvent.

(b) Production Method of Positive Electrode:

VGCF (from Showa Denko K.K.) as a conductive agent is added to a lithium-manganese composite oxide (LiMn₂O₄) material as a positive electrode active material, and this mixture is dispersed in N-methylpyrolidone (NMP) to make slurry. After that, the slurry is applied on an aluminum foil functioning as a positive electrode collector and dried. A positive electrode with a diameter of 12 mm is produced.

(c) Production Method of Negative Electrode:

A graphite material functioning as a negative electrode active material is dispersed in N-methylpyrolidone (NMP) to make slurry. The slurry is then applied on a copper foil functioning as a negative electrode collector and dried. After that, an electrode with a diameter of 12 mm is produced.

(d) Production Method of Coin Type Secondary Battery:

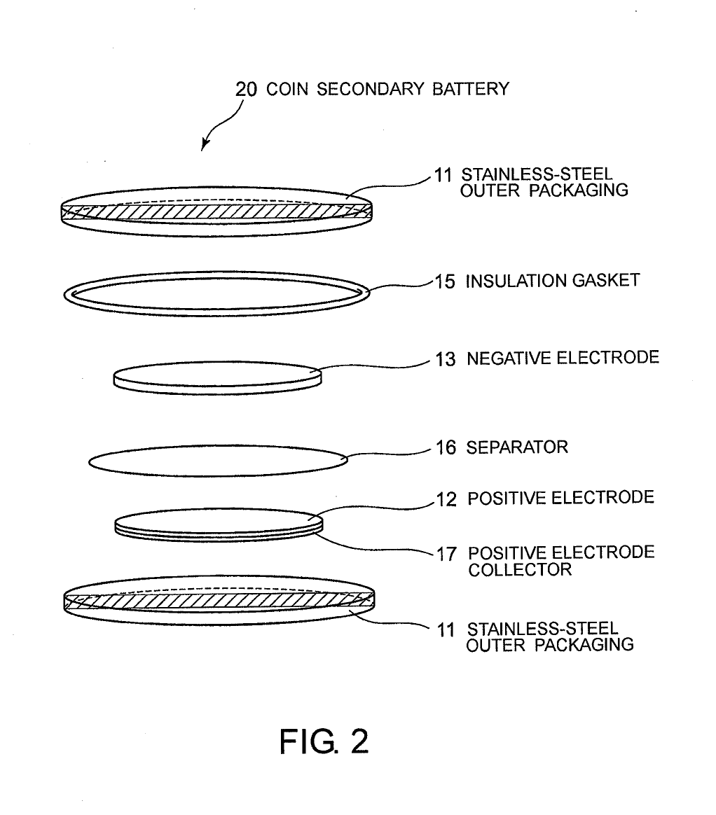

FIG. 2 is an exploded perspective view illustrating an example of assembly of a coin type secondary battery produced according to this invention. A method of producing the coin type secondary battery 20 will be described with reference to FIG. 2.

Referring to FIG. 2, a positive electrode 12 produced by the method described in (b) above is placed on a positive electrode collector 17 made of stainless-steel and serving also as a coin-cell tray, and a negative electrode 13 comprising graphite is placed with a separator 16 formed of a porous polyethylene film interposed between the positive and negative electrodes, whereby an electrode layered body is obtained. The electrolyte solution obtained by the method described in (a) above is injected into the electrode layered body and vacuum-impregnated thereinto. The electrolyte solution is impregnated enough such that the gaps between the electrodes and the separator is filled with the electrolyte solution. Then, an insulation gasket 15 is placed over the negative electrode collector serving also as a coin-cell tray and the layered body thus obtained is covered from the outside with a stainless-steel outer packaging 11 by means of a special caulker to integrate them, whereby a coin type secondary battery is produced.

### Working Examples

The invention will be described more specifically based on working examples thereof. In each of Examples 1 to 4 of the invention, a coin-type lithium ion secondary battery was produced with use of the organic solvent and the phosphorus compound described above, and measurement of discharge capacity of the secondary battery and a flammability test of the electrolyte solution were conducted. Comparative Examples 1 to 3 were also produced for the purpose of comparison and also subjected to measurement of discharge capacity.

Specific procedures are as described below.

### <Preparation of Samples>

Samples of electrolyte solutions and secondary batteries were prepared under the following conditions.

### Example 1

LiPF₆ was dissolved in an electrolyte solution comprising a composition of EC:DEC (30:70) in such an amount that the concentration of the LiPF₆ became 1.0 mol/L (1.0M). A Mg electrode and a Cu electrode were immersed in the electrode and mutually connected with copper wire for five minutes. After removing the electrodes, the electrolyte solution was used as an electrolyte while a LiMn₂O₄ active material was used as the positive electrode and graphite was used as the negative electrode, whereby a secondary battery was produced.

### Example 2

LiPF₆ was dissolved in an electrolyte solution comprising a composition of EC:DEC (30:70) in such an amount that the concentration of the LiPF₆ became 1.0 mol/L (1.0M). An Al electrode and a Pt electrode were immersed in the electrode and mutually connected with copper wire for five minutes. After removing the electrodes, the electrolyte solution was used as an electrolyte while a LiMn₂O₄ active material was used as the positive electrode and graphite was used as the negative electrode, whereby a secondary battery was produced.

### Example 3

LiPF₆ was dissolved in an electrolyte solution comprising a composition of EC:DEC (30:70) in such an amount that the concentration of the LiPF₆ became 1.0 mol/L (1.0M). A Sn electrode and a Cu electrode were immersed in the electrode and mutually connected with copper wire for three minutes. After removing the electrodes, the electrolyte solution was used as an electrolyte while a LiMn₂O₄ active material was used as the positive electrode and graphite was used as the negative electrode, whereby a secondary battery was produced.

### Example 4

LiPF₆ was dissolved in a solution in which trimethyl phosphate (hereafter, abbreviated as TMP) and EC/DEC (3:7) were mixed in a volume ratio of 40:60 (TMP/EC/DEC=40/18/42) in such an amount that the concentration of the LiPF₆ became 2.0 mol/L (2.0M), and 2% by weight of propane sultone (hereafter, abbreviated as PS) was added as an additive. A Mg electrode and a Cu electrode were immersed in the electrolyte solution thus obtained and mutually connected with copper wire for five minutes. After removing the electrodes, the electrolyte solution was used as an electrolyte while a LiMn₂O₄ active material was used as the positive electrode and graphite was used as the negative electrode, whereby a secondary battery was produced.

### Comparative Examples 1

LiPF₆ was dissolved in an electrolyte solution comprising a composition of EC:DEC (30:70) in such an amount that the concentration of the LiPF₆ became 1.0 mol/L (1.0M) and the solution thus obtained was used as an electrolyte solution. Except for this electrolyte solution, the same positive and negative electrodes as those of Example 1 were used, whereby a secondary battery was produced.

### Comparative Examples 2

LiPF₆ and 200 ppm Mg(OH)₂ were dissolved in an electrolyte solution comprising a composition of EC:DEC (30:70), LiPF₆ being dissolved in such an amount that the concentration of the LiPF₆ became 1.0 mol/L (1.0M), and the solution thus obtained was used as an electrolyte solution. Except for the electrolyte solution, the same positive and negative electrodes as those of Example 1 were used, whereby a secondary battery was produced.

### Comparative Examples 3

LiPF₆ was dissolved in an electrolyte solution comprising a composition of TMP:EC:DEC (40:18:42) in such an amount that the concentration of the LiPF₆ became 2.0 mol/L (2.0M) and 2% by weight of PS was added thereto. The solution thus obtained was used as an electrolyte solution. A positive electrode made of a LiMn₂O₄ active material and a negative electrode comprising graphite were used to produce a secondary battery.

<Measurement of Discharge Capacity>

An initial discharge capacity was measured for each of the samples of Examples 1 to 4 and Comparative Examples 1 and 2.

Specifically, the measurement was conducted by using each of the coin-type lithium secondary batteries produced by the methods described above, and charging and discharging it with a current of 0.073 mA. The initial discharge capacities thus obtained are shown in Table 1 below. Capacity maintenance factor after 50 cycles was measured by a method in which the battery was charged and discharged with a current of 0.58 mA, and a ratio of discharge capacity at the 50th cycle to discharge capacity at the second cycle was determined as the capacity maintenance factor after 50 cycles. The discharge capacities notated herein were values which were recalculated for the respective positive electrode active materials.

Evaluation results of discharge capacity for the samples of Examples 1 to 4 and Comparative Examples 1 and 2 are shown in Table 1 below. A capacity maintenance factor represented by a ratio between an initial discharge capacity and a discharge capacity after 50 cycles is indicated for each of the discharge capacity evaluation results of the coin type secondary batteries.

TABLE 1

| | | Capacity maintenance |
|---|---|---|
| | Initial discharge capacity | factor after 50 cycles |
| Example 1 | 120 mAh/g | 98% |
| Example 2 | 120 mAh/g | 98% |
| Example 3 | 119 mAh/g | 97% |
| Example 4 | 110 mAh/g | 88% |
| Com. Example 1 | 115 mAh/g | 95% |
| Com. Example 2 | 116 mAh/g | 95% |
| Com. Example 3 | 106 mAh/g | 72% |

Next, evaluation results of the coin type secondary batteries produced in the Examples 1 to 4 and Comparative Examples 1 to 3 will be described.

The initial discharge capacities obtained by charging and discharging the coin type secondary batteries produced as described above with a current of 0.073 mA are shown in Table 1 above.

In Comparative Examples 1, good cycle characteristics are obtained in the electrolyte solution of EC:DEC comprising LiPF₆ dissolved therein. On the other hand, in Example 1 of this invention using the electrolyte solution obtained by immersing Mg and Cu metals in the electrolyte solution of Comparative Examples 1 and connecting them with an electron-conductive material such as copper wire, improvement of discharge capacity was confirmed in the cycle characteristics. It is believed this is because a metal with high ionization tendency was dissolved as ions in the electrolyte solution by short-circuiting two different metals in the electrolyte solution. And it is estimated that these ions were deposited on the negative or positive electrode during charge and discharge, exerting influence on formation or composition of a solid electrolyte interface (hereafter, abbreviated as SEI). Otherwise, it is also presumable that precipitation of a metal with low ionization tendency exerted an effect to remove metal ions other than a light amount of lithium ions when the electrolyte solution was prepared.

This presumption is based on the fact that as shown in Comparative Examples 2, a significant effect (improvement of discharge capacity) cannot be obtained if magnesium ions are injected only by dissolving Mg(OH)₂. This result suggests that a slight amount of metal ion with low ionization tendency present in the electrolyte solution exerts influence on cycle characteristics.

It is believed that in Example 1 described above, Mg ions were dissolved in the electrolyte solution because the Mg metal has higher ionization tendency than the Cu metal. It is found that as shown in Examples 2 and 3, the same effect could be obtained even if types of metals immersed in the electrolyte solution were changed. Since a higher initial discharge capacity and a higher capacity maintenance factor could be obtained when Mg or Al was used, it is more desirable to use these metals for the electrodes and to inject ions thereof into the electrolyte solution.

Further, as shown in Example 4 and Comparative Examples 3, the same effect could be observed also in the electrolyte solution comprising TMP as a phosphorus compound added therein and both of the initial discharge capacity and cycle characteristics were improved. Improvement in maintenance factor after 50 cycles was particularly remarkable. It is believed this is because metal ions in the electrolyte solution were reduced into a metal and deposited on the graphite negative electrode during the initial charge and discharge to form a solid SEI, and decomposition of the phosphorus compound with low reduction stability was suppressed thereby. In other words, any side reaction caused by the charge and discharged was suppressed by the SEI, and capacity deterioration was prevented thereby.

<Flammability Test>

A flammability test was conducted on each of the electrolyte solutions of Examples 1 to 4 by bringing glass fibers impregnated with the electrolyte solution close to a gas burner flame for two seconds, then taking them away from the flame, and observing whether or not the electrolyte solution was burned.

When the glass fibers impregnated with the electrolyte solution of Example 4 was brought close to a gas burner flame for two seconds and then taken away from the flame, no fire was observed on the glass fibers. When the electrolyte solutions of Examples 1 to 3 were subjected to the same test, they continued to burn even after they were taken away from the flame.

It was apparent from these results that the addition of ester phosphate improved the fire retardancy of the electrolyte solution.

### CONCLUSION

As described above, in the secondary battery according to the invention, the characteristics of the electricity storage device can be improved by optimizing the electrolyte solution. The secondary battery according to the invention comprises, at least, a positive electrode, a negative electrode, and an electrolyte solution. The positive electrode is made of an oxide which occludes and releases lithium ions, and the negative electrode is made of a material which occludes and releases lithium ions. The electrolyte solution contains metal ions other than lithium ions, which are injected by immersing in an aprotic organic solvent comprising a lithium salt dissolved therein two different metals mutually connected by means of an electrically conductive material.

While the fire retardancy of the electrolyte solution can be improved by adding 15% by volume or more of a phosphorus compound, the mixing ratio of the phosphorus compound should desirably be as high as possible in order to obtain a higher fire retardant effect. Preferably, the mixing ratio is 20% by volume or more, and most preferably 25% by volume or more.

Although according to the invention, metal ions other than lithium ions are contained in an electrolyte solution comprising a lithium salt dissolved therein, an additive may be added in order to further improve the characteristics. When adding an additive, however, the amount of the additive need be limited to less than 10% in order to avoid deterioration of the discharge rate characteristics.

While the invention has been described based on its exemplary embodiments and working examples, the invention is not limited to these embodiments or working examples. It will be obvious to those skilled in the art that various changes and modifications may be made in the configuration and details of the invention without departing from the scope of the invention.

The electrolyte solution and the secondary battery according to the invention, as described above, are applicable to all uses as storage batteries or power supplies.

This application is based upon and claims the benefit of priority from Japanese Patent Application No. 2010-034973 filed Feb. 19, 2010, the disclosure of which is incorporated herein in its entirety by reference.

1. An electrolyte solution containing 20% by volume or more of a phosphorus compound, and metal ions other than lithium ions which are injected into an organic solvent comprising a lithium salt dissolved therein by immersing in the organic solvent two different metals mutually connected by means of an electrically conductive material.

2. The electrolyte solution according to claims 1, wherein the metal ions comprise at least either magnesium ions or aluminum ions.

3. (canceled)

4. The electrolyte solution according to claim 1, wherein 1.0 M (mol/L) or more of a lithium salt is dissolved in the electrolyte solution.

5. A secondary battery comprising a positive electrode containing an oxide capable of occluding and releasing lithium ions, a negative electrode containing a material capable of occluding and releasing lithium ions, and an electrolyte solution, the electrolyte solution being the electrolyte solution according to claim 1.

6. A method of manufacturing an electrolyte solution characterized by injecting, into an organic solvent comprising a lithium salt dissolved therein, metal ions other than lithium ions by immersing in the solvent two different metals mutually connected by means of an electrically conductive material.

7. The method of manufacturing an electrolyte solution according to claim 6, wherein the metal ions comprise at least either magnesium ions or aluminum ions.
